(19) United States
(12) Patent Application Publication
(10) Pub. No.: US 2025/0304849 A1
(43) Pub. Date: Oct. 2, 2025

(54) MIXTURES FOR INHIBITING ASPHALTENE DEPOSITION

(71) Applicant: ChampionX LLC, Sugar Land, TX (US)

(72) Inventors: Fang Wei, Houston, TX (US); Corbin Julian Metoyer, Pearland, TX (US); Jeremy Wayne Bartels, Sugar Land, TX (US); Christopher Alexander Russell, Sugar Land, TX (US)

(21) Appl. No.: 19/095,426

(22) Filed: Mar. 31, 2025

Related U.S. Application Data
(60) Provisional application No. 63/572,651, filed on Apr. 1, 2024.

(51) Int. Cl. C09K 8/524; E21B 37/06

(52) U.S. Cl. CPC C09K 8/524; E21B 37/06

(57) ABSTRACT

Asphaltene inhibiting compositions include a mixture of a sulfonate material with an amine condensate. The sulfonate material includes one or more sulfonate salts, one or more sulfonate polymers, or a mixture thereof; and the amine condensate includes a reaction product of one or more organic acids with one or more organic compounds having at least two amine groups. The asphaltene inhibiting compositions can form stable injection solutions suitable for use in subsea umbilicals. Combinations of crude oil with the asphaltene inhibiting compositions undergo reduced, or inhibited, asphaltene deposition onto liquid-solid interfaces when compared to asphaltene deposition of the same crude oil in the absence of the composition. The asphaltene inhibiting compositions are particularly effective for inhibiting deposition of coke-like asphaltenes.

### BACKGROUND

During the recovery of crude oil from a wellhead, one or more chemicals are often employed to obtain control of the properties of the crude oil stream. Thus, for example, one or more antipolymerants, dispersants, corrosion inhibitors, and the like are routinely applied at a wellhead by an operator in order to obtain control of the properties of the crude oil emanating therefrom and also to maintain the operability of oil recovery and processing equipment over time by preventing corrosion of surfaces contacted by the crude oil, and further preventing precipitation of e.g. waxes and polymerized reaction products within the pipes and tanks used in the recovery process, and. The chemistries employed in such control formulations generally improve efficiency of the oil recovery process by ensuring a consistent flow of crude oil, and by maintaining operability and minimizing down time of the mechanical equipment that contacts the crude oil during recovery, refining, and storage thereof.

Asphaltenes are a solubility class of crude oil, defined as the crude oil fraction that is soluble in aromatic solvents and insoluble in n-alkanes. ASTM D-3279-90 defines asphaltenes as solids that precipitate when an excess of n-heptane or pentane is added to a crude oil. Asphaltene molecules have complex structures and may precipitate from crude oil during extraction, forming deposits on the internal surface of the production system and accumulating particularly within equipment with high crude oil residence time. Asphaltenes are typically stable under virgin reservoir conditions, but during production, they can become destabilized and precipitate. The precipitated asphaltenes tend to become deposited on the surfaces of the one or more tubes, pipes, separators, or containments contacted by the crude oil, and are a major source of crude oil flow and processing issues.

Accordingly, there is an ongoing need for development of chemicals that reduce or prevent deposition of asphaltenes from crude oil during recovery of the crude oil from a producing wellhead. This need is greatest in the offshore oil and gas industry, where umbilical lines, or “umbilicals”, are used to convey control and production treatment fluids from a platform on the sea surface to a subsea wellhead. As oil production obtains increasingly marginal field developments and ever-increasing water depths, emphasis is increasingly placed on remote and deepwater subsea production systems, where the umbilical is one of the most critical components of complex subsea oil recovery systems.

Operationally, fluids transported via umbilicals must withstand the harsh environmental conditions to which they are subjected not just at the wellhead, but while traversing the umbilical toward the wellhead to obtain injection. An injection fluid traversing an umbilical to a subsea depth of 1200-1550 m may be subjected to pressures of about 40 MPa at the wellhead, and is further subjected to widely variable temperatures during the traversing. For example, a temperature within a reservoir may be as high as 90° C., or even higher, while the temperature at the subsea mud-line is often less than 20° C., in some cases as low as 0-5° C. To be useful in umbilical injection, an injected fluid must remain substantially in a single fluid phase

Accordingly, there is an ongoing need for development of chemicals that reduce or prevent deposition asphaltene in crude oil, and further are sufficiently stable in an injection fluid for umbilical injection into subsea wellheads.

### SUMMARY

Disclosed herein are asphaltene inhibiting compositions (AI composition) comprising, consisting essentially of, or consisting of a mixture of a sulfonate material with an amine condensate. In embodiments, the weight proportion of the sulfonate material to the amine condensate in the AI composition is between 100:1 and 1:100.

In embodiments, the sulfonate material comprises, consists essentially of, or consists of one or more compounds selected from sulfonate salts and sulfonate polymers. In embodiments, the sulfonate material comprises, consists essentially of, or consists of one or more sulfonate salts and one or more sulfonate polymers present in a proportion between 100:1 and 1:100.

In embodiments, the one or more sulfonate salts have a structure corresponding to the formula (R—SO³⁻)ₙXⁿ⁺, wherein n is an integer between 1 and 4, R is a hydrocarbyl moiety having between 10 and 40 carbons and optionally including one or more hydroxyl moieties, and where n=1, X is Na, Ka, Li, K, NH₄, NH₃—CH₂—CH₂—OH, or NH₂(CH₂—CH₂—OH)₂; where n=2, X is Mg, Zn, Zr, Ba, or Ca; where n=3, X is Al, Mn, or Fe; and where n=4, X is Ti or Zr.

In embodiments, the one or more sulfonate polymers is a poly(methylene naphthalene sulfonate) homopolymer or copolymer.

In embodiments, the amine condensate comprises, consists essentially of, or consists of a reaction product of one or more organic acids with one or more organic compounds having at least two amine groups, and in embodiments at least two primary amine groups. In embodiments, the amine condensate comprises, consists essentially of, or consists of an imidazoline, an amidoamine, or a combination of two or more thereof.

Also disclosed herein are injectable AI compositions comprising, consisting essentially of, or consisting of 0.1 ppm to 10,000 ppm by weight of an AI composition in a solvent, wherein the solvent is selected from toluene, xylene, heavy aromatic naphtha, diesel fuels, kerosenes, heavy aromatic distillates, gasolines, or any mixture thereof. In embodiments, an injectable AI composition includes 0.1 ppm to 1000 ppm by weight of an AI composition in a solvent. In embodiments, an injectable AI composition is a solution. In embodiments, an injectable AI solution is stable, that is, it does not undergo phase separation when subjected to conditions of temperature and pressure present during one or more subsea umbilical injections. Accordingly, in embodiments, an injectable AI composition is disposed within a subsea umbilical, wherein the subsea umbilical is in fluid contact with a subsea reservoir. In embodiments, the subsea umbilical is one part of a subsea tree.

Also disclosed herein are methods of recovering a hydrocarbon from a reservoir, the methods comprising, consisting essentially of, or consisting of combining a solvent with 0.1 ppm to 10,000 ppm by weight of an AI composition to form an injectable AI composition; contacting the injectable AI composition with a crude oil disposed within the reservoir to form a treated crude oil; and collecting the treated crude oil from the reservoir. In embodiments, the reservoir is a subsea reservoir, and the contacting includes applying the injectable AI composition to a subsea umbilical, and flowing the injectable AI composition through the subsea umbilical and into the subsea reservoir. In embodiments, a temperature proximal to the injectable AI composition during the flowing is between 0° C. and 90° C. In embodiments, a temperature proximal to the injectable AI composition varies by 5° C. to 90° C. during the flowing. In embodiments, a pressure proximal to the injectable AI composition during the flowing is 0.1 MPa to 40 MPa. In embodiments, a pressure proximal to the treatment composition varies by 0.1 MPa to 40 MPa during the flowing. In embodiments, the injectable AI composition is an injectable AI solution. In embodiments, the injectable AI solution is a stable injectable AI solution, where “stable” in such context means that the injectable AI solution does not undergo phase separation, freezing, or gelation during the flowing.

Also disclosed herein are treated crude oils. A treated crude oil includes a crude oil and 0.1 ppm to 10,000 ppm by weight of an AI composition. In embodiments, a treated crude oil obtains a 30%-99% reduction in asphaltene fouling compared to an untreated crude oil obtained from the same reservoir—that is, a crude oil that does not include any compounds attributable to an AI composition as described herein. Further, a treated crude oil obtains a 5%-50% reduction in asphaltene fouling compared to a crude oil obtained from the same reservoir and including 0.1 ppm to 10,000 ppm by weight of a sulfonate material, in the absence of the amine condensate. That is, the combination of sulfonate material and amine condensate obtains improved asphaltene inhibition performance in a crude oil when compared to the sulfonate material alone. This finding is unexpected because amine condensates are not associated with asphaltene inhibition and do not obtain asphaltene inhibition in the absence of the sulfonate material.

### DETAILED DESCRIPTION

Various embodiments will now be described in detail. Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

### Definitions

As used herein, the term “asphaltene” refers to the component of crude oil, bitumen, or coal that is toluene-soluble and n-heptane-insoluble; in embodiments, asphaltene is a solid, or consists essentially of a solid at 25° C./1 atm.

As used herein, “asphaltene fouling”, “asphaltene deposition”, and like terms refers to the association of asphaltene with a solid-liquid interface; unless otherwise determined by context, asphaltene fouling refers to the deposition of asphaltene from a crude oil onto the surface of one or more tubes, pipes, or other equipment contacted with the crude oil during extraction and transport thereof.

As used herein, “asphaltene inhibition” refers to a reduction of asphaltene fouling, or a method of reducing asphaltene fouling.

As used herein, the term “solvent” means a single compound or a mixture of two or more compounds, wherein the compound or mixture thereof is liquid or substantially liquid within at least a portion of the range between 0° C. and 100° C. at 1 atm.

As used herein, the term “oil” refers to a compound, or a mixture of two or more compounds, that is liquid at 25° C./1 atm, is insoluble in water, and has a flashpoint of greater than 100° C.

As used herein, the term “soluble”, “dissolved” and similar terms as applied generally to a compound in a liquid means 1 wt % or more of the compound is dissolved or is capable of dissolving in the liquid at 15° C./1 atm. As applied to a polymer in a liquid, “soluble”, “dissolved” and similar terms indicate that the polymer is completely solvated and homogeneously dispersed within the liquid, or is capable of becoming completely solvated and homogeneously dispersed in the liquid.

As used herein the term “insoluble” as applied generally to a compound in a liquid means less than 1 wt % or more of the compound is dissolved or is capable of dissolving in the liquid at 15° C./1 atm.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### DISCUSSION

Disclosed herein are asphaltene inhibiting compositions (AI composition) comprising, consisting essentially of, or consisting of a mixture of a sulfonate material with an amine condensate. In embodiments, the proportion of the sulfonate material to the amine condensate in the AI composition is between 100:1 and 1:100 by weight, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 by weight.

In embodiments, the sulfonate material comprises, consists essentially of, or consists of one or more sulfonate salts, one or more sulfonate polymers, or any mixture thereof. In embodiments, the sulfonate material comprises, consists essentially of, or consists of one or more compounds selected from sulfonate salts and one or more compounds selected from sulfonate polymers. In such embodiments, the proportion of the one or more sulfonate salts to the one or more sulfonate polymers is between 100:1 and 1:100 by weight, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 by weight.

In embodiments, a sulfonate salt is a conjugate base of a sulfonic acid having a structure corresponding to the formula R—SO₃H, wherein R is an organic group. In embodiments, R is a hydrocarbyl moiety. In embodiments, R is a linear, branched, or cyclic aliphatic, aromatic, aralkyl, or alkaryl moiety. In embodiments, R includes between 10 and 40 carbon atoms. In embodiments, R further includes one or more oxygen atoms. In embodiments, one or more of the one or more oxygen atoms is part of a hydroxyl group.

In embodiments, a sulfonate salt of the AI composition has a chemical structure corresponding to formula (1),

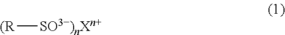

wherein R is the same as above; n is an integer between 1 and 4, that is, n has a value of 1, 2, 3, or 4. In embodiments of formula (1) where n is 1, X is a monovalent cation or a mixture of two or more sulfonate salts having different monovalent cations. In such embodiments, X comprises, consists essentially of, or consists of Na, Ka, Li, K, NH₄, NH₃—CH₂—CH₂—OH, NH₂(CH₂—CH₂—OH)₂, or a mixture of two or more thereof, further wherein a mixture of any two monovalent cations is obtained in a molar proportion of 1000:1 to 1:1000, or 500:1 to 1:500, or 100:1 to 1:100, 10:1 to 1:10, 5:1 to 1:5, 2:1 to 1:2, or even about 1:1. In embodiments, a sulfonate salt is a sodium sulfonate, an ammonium sulfonate, or a mixture thereof.

In embodiments of formula (1) where n is 2, X is a divalent cation or a mixture of two or more sulfonate salts having different divalent cations. In embodiments, X comprises, consists essentially of, or consists of Mg, Zn, Zr, Ba, Ca, or a mixture of two or more thereof, further wherein a mixture of any two divalent cations is obtained in a molar proportion of 1000:1 to 1:1000, or 500:1 to 1:500, or 100:1 to 1:100, 10:1 to 1:10, 5:1 to 1:5, 2:1 to 1:2, or about 1:1.

In embodiments of formula (1) where n is 3, X is a trivalent cation or a mixture of two or more sulfonate salts having different trivalent cations. In embodiments, X comprises, consists essentially of, or consists of Al, Mn, or Fe or a mixture of two or more thereof, further wherein a mixture of any two trivalent cations is obtained in a molar proportion of 1000:1 to 1:1000, or 500:1 to 1:500, or 100:1 to 1:100, 10:1 to 1:10, 5:1 to 1:5, 2:1 to 1:2, or about 1:1.

In embodiments of formula (1) where n is 4, X is a tetravalent cation or a mixture of two or more sulfonate salts having different tetravalent cations. In embodiments, X comprises, consists essentially of, or consists of Ti, Zr, or a mixture thereof, further wherein a mixture of any two tetravalent cations is obtained in a molar proportion of 1000:1 to 1:1000, or 500:1 to 1:500, or 100:1 to 1:100, 10:1 to 1:10, 5:1 to 1:5, 2:1 to 1:2, or even about 1:1.

In embodiments, the sulfonate salt has a chemical structure corresponding to formula (1) wherein R is phenyl, naphthyl, anthracenyl, isododecyl, or an alkaryl selected from a 2-alkaryl, 3-alkaryl, or 2,3-dialkylaryl. In embodiments, the aryl moiety of the 2-alkaryl, 3-alkaryl, or 2,3-dialkylaryl is phenyl, naphthyl, or anthracenyl; and the one or two alkyl moieties of the 2-alkaryl, 3-alkaryl, or 2,3-dialkylaryl are independently selected from C1-C20 hydrocarbyl groups including but not limited to linear and branched alkyl and alkenyl groups including but not limited to n-hexyl, n-heptyl, n-octyl, n-nonyl, n-decyl, n-undecyl, n-dodecyl, n-hexadecyl, n-octadecyl, isohexyl, isoheptyl, isooctyl, isononyl, isodecyl, isoundecyl, isododecyl, hexenyl, heptentyl, octenyl, nonenyl, decenyl, undecenyl, dodecenyl, hexadecyl, hexadecenyl, octadecyl, octadecenyl, and more highly branched alkyl and alkenyl moieties. In embodiments, the two alkyl moieties of the 2,3-dialkylaryl are the same. In embodiments, the sulfonate salt has a chemical structure corresponding to formula (1) wherein n=1 and X═Na or NH₄. In embodiments, the sulfonate salt comprises, consists essentially of, or consists of ammonium diisononyl naphthalene sulfonate. In embodiments, the sulfonate salt comprises, consists essentially of, or consists of sodium diisononyl naphthalene sulfonate. In embodiments the sulfonate salt comprises, consists essentially of, or consists of a salt of one or more of the following sulfonates having chemical structures corresponding to formulae (1a)-(1f):

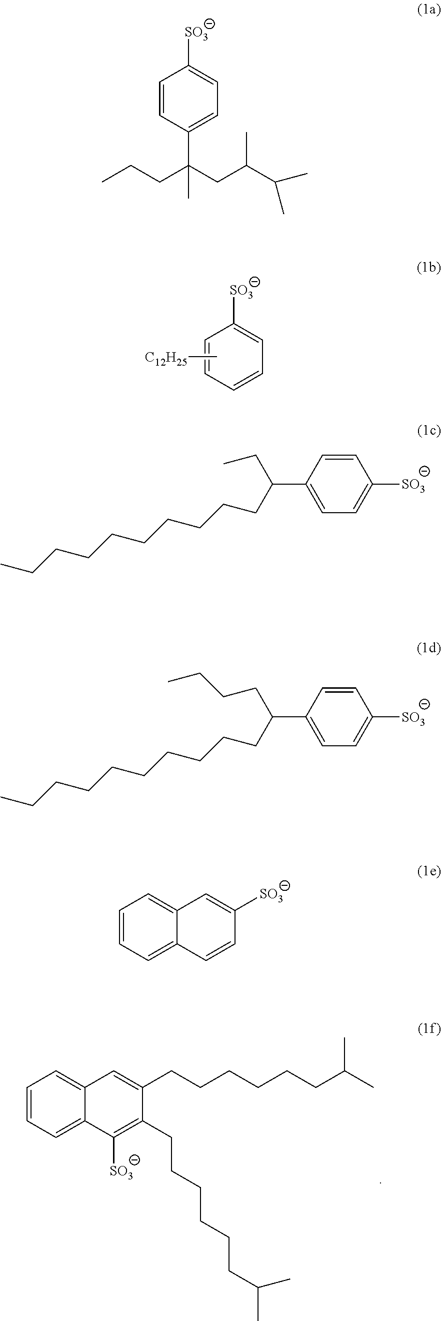

In embodiments, the salts of the sulfonate structures corresponding to formulae (1a)-(1f) are ammonium salts. In embodiments, the salts of the sulfonate structures corresponding to formulae (1a)-(1f) are sodium salts.

In embodiments, the one or more sulfonate salts are insoluble in water. As used herein, the term “insoluble in water” means less than 1 wt % of a sulfonate salt dissolves in pure water at 15° C./1 atm. In other embodiments, one or more sulfonate salts are soluble in water, that is, 1 wt % or more of the sulfonate salt dissolves in pure water at 15° C./1 atm.

In embodiments, the one or more sulfonate salts comprise, consist essentially of, or consist of an overbased sulfonate detergent or a highly overbased sulfonate detergent. Overbased sulfonate detergents are mixtures, typically supplied as a dispersion in an oil, of an amorphous calcium carbonate particulate stabilized by a sulfonate salt.

In embodiments, the sulfonate salt is a mixture of two or more different compounds having a chemical structure corresponding to formula (1), wherein a first portion of the sulfonate salt mixture includes a first compound having a first value of n that is n′; and a second portion of the sulfonate salt mixture includes a second compound having a second value of n′ that is n″; wherein n′ and n″ are individually integers between 1 and 4, and further wherein n′ and n″ are different. Similarly, sulfonate salt mixtures including three or more different sulfonate salt species, wherein each of the three or more different sulfonate salt species has a chemical structure corresponding to formula (1), and each of the three or more sulfonate salt species have different values of n, R, or both n and R are contemplated. In such embodiments, the relative amounts, or molar proportions of the three of more different sulfonate salt species of the sulfonate salt mixture are not particularly limited; and often obtain a molar proportion of 100:1 to 1:100, 10:1 to 1:10, 5:1 to 1:5, 2:1 to 1:2, or about 1:1 as to between any two sulfonate salt species.

In some embodiments, the sulfonate salt is a mixture of two or more sulfonate salt species, each specie having a chemical structure corresponding to formula (1), wherein a first portion of the sulfonate salt mixture is a first sulfonate salt specie having a first R group that is R′; and a second portion of the sulfonate salt mixture is a second sulfonate salt specie having a second R group that is R″; wherein a comparison of R′ and R″ obtains one or more of the following differences: different number of carbon atoms, different degree of branching, cyclic vs. branched structure, branched vs. linear structure, cyclic vs. linear structure, aromatic vs. aliphatic structure, or some other chemical, structural, or isomeric difference. In embodiments, the sulfonate salt is a mixture of two or more different sulfonate salt species, each sulfonate salt specie having a chemical structure corresponding to formula (1), wherein the two or more different sulfonate salt species have different R groups, different values of n, or both different R groups and different values of n. Accordingly, in embodiments, the sulfonate salt is a sulfonate salt mixture of two or more different sulfonate salt species, each having a chemical structure corresponding to formula (1), wherein a first portion of the sulfonate salt mixture is a first sulfonate salt specie having a first R group that is R′ and a first value of n that is n′ (thus, (R′—SO³—)_{n′}X^{n′+}); and a second portion of the sulfonate salt mixture is a second sulfonate salt specie having a second R group that is R″ and a second value of n′ that is n″ (thus, (R″—SO³⁻)_{n′}X^{n′+}); wherein n′, n″ are each independently as defined for n above; and wherein R′, R″ are each independently as defined for R above.

In embodiments, a sulfonate polymer of the instant AI composition includes one or more sulfonate repeating units, that is, one or more repeating units having one or more sulfonate moieties bonded thereto. In embodiments, the total number of sulfonate repeating units in the sulfonate polymer is between 1 and 10,000. In embodiments, the sulfonate polymer is a sulfonate homopolymer; in other embodiments the sulfonate polymer is a sulfonate copolymer. In embodiments, a sulfonate homopolymer consists of single sulfonate repeating unit, repeated 3 to 10,000 times. In embodiments, a sulfonate copolymer includes one or more sulfonate repeating units and one or more additional repeating units, wherein the total number of repeating units is between 3 and 10,000. In embodiments, one or more of the one or more additional repeating units of the sulfonate copolymer includes one or more sulfonate moieties—that is, the copolymer includes two or more different sulfonate repeating units. In embodiments, one or more of the additional repeating units excludes sulfonate moieties.

In embodiments, a sulfonate polymer of the instant AI composition is or includes one or more sulfonate homopolymers, one or more sulfonate copolymers, or a mixture of one or more sulfonate homopolymers with one or more sulfonate copolymers, in any proportion e.g. in any weight proportion between 100:1 and 1:100. For example, two or more different sulfonate homopolymers; two or more different sulfonate copolymers; or one or more sulfonate homopolymer and one or more sulfonate copolymer may be suitably admixed together, or are formed together as a result of the synthetic method employed to result in the sulfonated polymer used in the treatment compositions.

In some embodiments, a sulfonate polymer of the instant AI composition comprises, consists essentially of, or consists of a poly(methylene naphthalene sulfonate). In embodiments, a poly(methylene naphthalene sulfonate) is formed by the condensation of β-naphthalene sulfonic acid with formaldehyde to obtain a poly(methylene naphthalene sulfonic acid), or pMNSA; and neutralization of some or all of the sulfonic acid moieties of the pMNSA to the corresponding conjugate base, a poly(methylene naphthalene sulfonate) (pMNS). In embodiments, the pMNSA is a homopolymer that is a formaldehyde condensate of β-naphthalene sulfonic acid. In other embodiments, the pMNSA is a copolymer that includes at least one repeating unit attributable to the condensation of formaldehyde with β-naphthalene sulfonic acid; at least one repeating unit attributable to the condensation of a formaldehyde with phenol, resorcinol, or another aromatic compound, or a mixture of two or more thereof; and a total of at least three (3) repeating units.

In embodiments, contacting a pMNSA with a metal hydroxide obtains a metal sulfonate polymer, that is, a conjugate base of the pMNSA, which is a poly(metal methylene naphthalene sulfonate). In embodiments, the metal hydroxide has a chemical structure corresponding to the formula Xⁿ⁺(OH)ₙ wherein n and X are as defined above for the sulfonate salt having formula (1): that is, n is 1, 2, 3, or 4; and where n is 1, X comprises, consists essentially of, or consists of Na, Ka, Li, K, NH₄, NH₃—CH₂—CH₂—OH, NH₂(CH₂—CH₂—OH)₂, or a mixture of two or more thereof; where n is 2, X comprises, consists essentially of, or consists of Mg, Zn, Zr, Ba, Ca, or a mixture of two or more thereof; where n is 3, X comprises, consists essentially of, or consists of Al, Mn, or Fe or a mixture of two or more thereof; and where n is 4, X comprises, consists essentially of, or consists of Ti, Zr, or a mixture thereof. Accordingly, in embodiments, upon contacting a pMNSA with a metal hydroxide, the pMNSA is partially or completely converted to the conjugate base thereof; that is, in some embodiments, all or substantially all of the sulfonic acid moieties of the pMNSA are converted to the conjugate base thereof (sulfonate); in other embodiments, only some of the sulfonic acid moieties of the pMNSA are converted to the conjugate base thereof.

In embodiments, contacting a pMNSA with sodium hydroxide obtains a sodium sulfonate polymer that is a poly(sodium methylene naphthalene sulfonate), or NaMNS. Similarly, contacting pMNSA with lithium hydroxide obtains a lithium sulfonate polymer that is a poly(lithium methylene naphthalene sulfonate), or LiMNS; contacting pMNSA with potassium hydroxide obtains a potassium sulfonate polymer that is a poly(potassium methylene naphthalene sulfonate), or KMNS; contacting pMNSA with ammonium hydroxide obtains an ammonium sulfonate polymer that is a poly(ammonium methylene naphthalene sulfonate), or NH₄MNS; and contacting pMNSA with ethanolammonium hydroxide or diethanolammonium hydroxide obtains (EtONH₃)MNS or ((EtO)₂NH₂)MNS, respectively.

In some embodiments, a pMNS has a chemical structure comprising one or more repeating units having formula (2) as shown below, wherein m is an integer of 1 or more, and X is Na, Ka, Li, K, NH₄, NH₃—CH₂—CH₂—OH, NH₂(CH₂—CH₂—OH)₂, or a mixture of two or more thereof (that is, different pMNS repeating units can have different X):

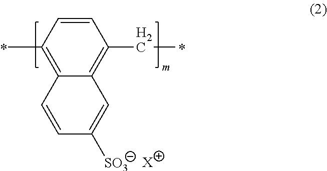

In some embodiments, a pMNS comprising one or more repeating units corresponding to formula (2) is a homopolymer, wherein m is an integer between 3 and 10,000, for example between 5 and 10,000; or between 10 and 10,000; or between 25 and 10,000; or between 50 and 10,000; or between 75 and 10,000; or between 100 and 10,000; or between 200 and 10,000; or between 300 and 10,000; or between 500 and 10,000; or between 700 and 10,000; or between 1000 and 10,000; or between 2000 and 10,000; or between 3000 and 10,000; or between 5000 and 10,000; or between 7000 and 10,000; or between 3 and 7,000; or between 3 and 5,000; or between 3 and 3,000; or between 3 and 2,000; or between 3 and 1,000; or between 3 and 500; or between 3 and 300; or between 3 and 200; or between 3 and 100; or between 3 and 50; or between 3 and 10; or between 3 and 5; or between 5 and 10; or between 10 and 50; or between 50 and 100; or between 100 and 300; or between 300 and 500; or between 500 and 700; or between 700 and 1000; or between 1000 and 2000; or between 2000 and 3000; or between 3000 and 5000; or between 5000 and 7000; or between 7000 and 10,000.

In some embodiments, a pMNS comprising one or more repeating units corresponding to formula (2) is a copolymer comprising, consisting essentially of, or consisting of a total of at least three repeating units, further wherein at least one of the repeating units corresponds to formula (2), that is, wherein m of formula (2) is at least 1. In other embodiments, the pMNSA comprising one or more repeating units corresponding to formula (2) is a copolymer further including at least one additional repeating unit attributable to the condensation of a formaldehyde with phenol, resorcinol, or another aromatic compound, or a mixture of two or more thereof. In embodiments, the total number of repeating units in a pMNS copolymer, that is the total number of repeating units corresponding to formula (2) plus the total number of additional repeating units, is between 3 and 10,000, for example between 5 and 10,000; or between 10 and 10,000; or between 25 and 10,000; or between 50 and 10,000; or between 75 and 10,000; or between 100 and 10,000; or between 200 and 10,000; or between 300 and 10,000; or between 500 and 10,000; or between 700 and 10,000; or between 1000 and 10,000; or between 2000 and 10,000; or between 3000 and 10,000; or between 5000 and 10,000; or between 7000 and 10,000; or between 3 and 7,000; or between 3 and 5,000; or between 3 and 3,000; or between 3 and 2,000; or between 3 and 1,000; or between 3 and 500; or between 3 and 300; or between 3 and 200; or between 3 and 100; or between 3 and 50; or between 3 and 10; or between 3 and 5; or between 5 and 10; or between 10 and 50; or between 50 and 100; or between 100 and 300; or between 300 and 500; or between 500 and 700; or between 700 and 1000; or between 1000 and 2000; or between 2000 and 3000; or between 3000 and 5000; or between 5000 and 7000; or between 7000 and 10,000.

In some embodiments, a pMNS copolymer includes a proportion of sulfonate repeating units to non-sulfonate repeating units (that is, repeating units having no sulfonate moiety) of 100:1 to 1:100, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1.

In some embodiments, a sulfonate polymer is a branched alkaryl backbone with pendant benzenesulfonate moieties. One exemplary branched sodium benzenesulfonate polymer structure is represented by formula (3). Other similar sulfonate polymer structures and formulae are contemplated. Conventionally, some branched or crosslinked polymers having pendant benzenesulfonate moieties such as the structure of formula (3), or a similar structure, are employed industrially as ion exchange resins.

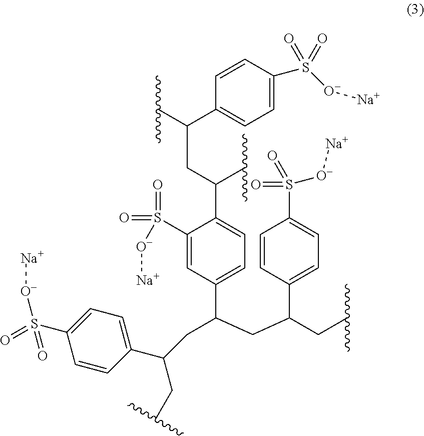

In embodiments, an amine condensate comprises, consists essentially of, or consists of a reaction product of one or more organic acids with one or more polyamines. In embodiments, the polyamine is an organic compound having two or more amine groups. In embodiments, at least one of the two or more amine groups is a primary amine group. In embodiments, the polyamine includes three amine groups, four amine groups, or five amine groups. In embodiments the organic polyamine has two or more primary amine groups. In embodiments, the polyamine comprises, consists essentially of, or consists of ethylene diamine, diethylene triamine, triethylenetetramine, tetraethylenepentamine, N-(2-aminoethyl)-1,2-ethanediamine, aminoethylethanolamine,

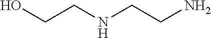

or a combination of two or more thereof.

In embodiments, the organic acid is a fatty acid. In embodiments, the fatty acid is a saturated fatty acid, a monounsaturated fatty acid, a polyunsaturated fatty acid, or a combination of two or more thereof. In embodiments, the fatty acid includes between 10 and 40 carbons, such as 16 to 40, or 18 to 40, or 20 to 40, or 10 to 35, or 10 to 30, or 16 to 35, or 16 to 30, or 18 to 35, or 18 to 30 carbons. In embodiments the fatty acid is a fatty acid mixture including two or more different fatty acids. In embodiments the fatty acid comprises, consists essentially of, or consists of tall oil fatty acid (including a majority content by weight of oleic acid), naphthenic acid, lauric acid, myristic acid, palmitic acid, palmitoleic acid, stearic acid, oleic acid, linoleic acid, arachidonic acid, or a combination of two or more thereof. In embodiments, the amine condensate is a reaction product of diethylene triamine with tall oil fatty acid. In embodiments, the amine condensate is a reaction product of diethylene triamine with oleic acid.

In embodiments, an amine condensate comprises, consists essentially of, or consists of an imidazoline. The term “imidazoline” refers to one or more members of the class of heterocycles derived from imidazoles by the reduction of one of the two double bonds. Unless specified otherwise, an imidazoline is a 2-imidazoline, a 3-imidazoline, a 4-imidazoline, or a mixture of two or more thereof. In embodiments, the imidazoline is a 2-imidazoline. In embodiments, the imidazoline has a chemical structure corresponding to formula (4),

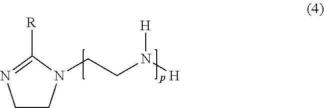

wherein R² is a linear or branched alkyl, alkenyl, alkaryl, or aryl group having 10 to 30 carbons and p is an integer between 1 and 5. In some embodiments, R² of formula (4) is the same as R of formula (1). In embodiments, p is 1 and the imidazoline has the chemical structure corresponding to formula (4a).

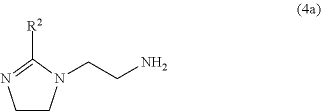

In embodiments, an amine condensate having a chemical structure corresponding to formula (4a) comprises, consists essentially of, or consists of a condensate of diethylene triamine (DETA) with tall oil fatty acid (TOFA) or a TOFA derivative. In some such embodiments of formula (4a), R² comprises C₁₇H₃₃, which a linear, monounsaturated residue of oleic acid. Tall oil fatty acid typically includes about 45% to about 50%, often about 48% by weight oleic acid as the major component thereof. Accordingly, in embodiments, an amine condensate having a chemical structure corresponding to formula (4a) comprises a mixture of compounds wherein 70 mole % to 90 mole % of the compounds comprise R₂ that is either C₁₇H₃₃ and C₁₇H₃₁. In embodiments, the mixture of compounds (4a) includes about 48 mole % of the compound (4a) wherein R₂ is C₁₇H₃₃ and about 42% mole % of the compound (4a) wherein R₂ is C₁₇H₃₁.

Accordingly, in embodiments, the amine condensate comprises, consists essentially of, or consists of a DETA/TOFA-imidazoline, a DETA/TOFA-imidazoline acrylate, or any combination thereof. In some embodiments, the amine condensate comprises, consists essentially of, or consists of one or more compounds having a chemical structure corresponding to formulae (4b)-(4f):

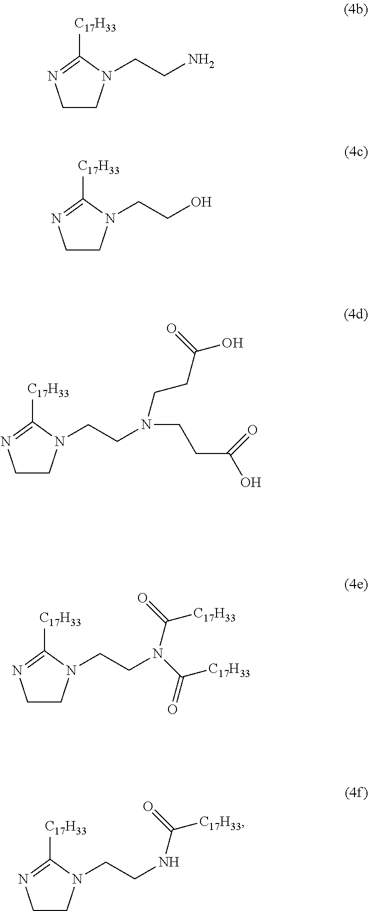

and any combination of these. In embodiments, an amine condensate comprises, consists essentially of, or consists of an imidazole derivative, that is, a structure that is similar to the structure shown in formula (4), for example any one or more of the structures shown in formulae (4a)-(4f), but having an imidazole moiety (two ring double bonds) in place of the imidazoline moiety.

In embodiments, an amine condensate comprises, consists essentially of, or consists of an amidoamine. In embodiments, the amidoamine has a chemical structure corresponding to formula (5),

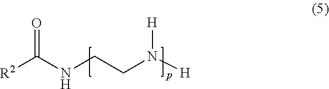

wherein R² and p are as defined for formula (4). In embodiments, p is 1 and the amidoamine has a chemical structure corresponding to formula (5a)

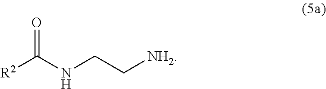

In some embodiments of formula (5a), R² comprises C₁₇H₃₃. In embodiments, an amine condensate having a chemical structure corresponding to formula (5a) comprises a mixture of compounds wherein 70 mole % to 90 mole % of the compounds comprise R₂ that is either C₁₇H₃₃ and C₁₇H₃₁. In embodiments, the mixture of compounds (5a) includes about 48 mole % of the compound (5a) wherein R₂ is C₁₇H₃₃ and about 42% mole % of the compound (5a) wherein R₂ is C₁₇H₃₁.

In embodiments, an amine condensate comprises, consists essentially of, or consists of a mixture of one or more imidazolines having a chemical structure corresponding to formula (4). In embodiments, an amine condensate comprises, consists essentially of, or consists of a mixture of one or more amindoamines having a chemical structure corresponding to formula (5). In embodiments, an amine condensate comprises, consists essentially of, or consists of a mixture of one or more imidazolines having a chemical structure corresponding to formula (4) and one or more amidoamines having a chemical structure corresponding to formula (5). In embodiments, the amine condensate comprises, consists essentially of, or consists of a mixture of compounds having chemical structures corresponding to formula (4a) and to formula (5a). In some embodiments, R² is the same for all the amine condensate compounds present in a mixture thereof. In some such embodiments, R² comprises C₁₇H₃₃, C₁₇H₃₁ or a mixture thereof.

Also disclosed herein are injectable AI compositions comprising, consisting essentially of, or consisting of a mixture of any one of the AI compositions described above further combined or mixed with a solvent. In embodiments, an injectable AI composition comprises, consists essentially of, or consists of 0.1 ppm to 10,000 ppm by weight of an AI composition in a solvent or, where indicated, 0.1 ppm to 10,000 ppm by weight/volume (w/v) of an AI composition in a solvent.

In embodiments, the solvent is a single compound or a mixture of two or more compounds that is liquid or substantially liquid within at least a portion of the range between 0° C. and 100° C. at 1 atmosphere pressure (1 atm). In embodiments, the portion of the range in which the solvent is a liquid or substantially a liquid includes at least the range between 5° C. and 30° C., or between 10° C. and 30° C. In embodiments, the solvent is insoluble in water. As used herein, the term “insoluble in water” means less than 1 wt % of the compound dissolves in pure water at 15° C./1 atm. In some embodiments, the AI composition is soluble in the solvent, that is, more than 1 wt % of the AI composition is capable of dissolving in the solvent at 15° C. In some such embodiments, more than 2 wt %, more than 5 wt %, more than 10 wt %, even more than 20 wt % of the AI composition is capable of dissolving in the solvent at 15° C.

In embodiments, an injectable AI composition comprises, consists essentially of, or consists of 0.1 ppm to 10,000 ppm by weight by weight or w/v (where specified) of an AI composition in a solvent, for example 1 ppm to 10,000 ppm, or 10 ppm to 10,000 ppm, or 50 ppm to 10,000 ppm, or 100 ppm to 10,000 ppm, or 200 ppm to 10,000 ppm, or 300 ppm to 10,000 ppm, or 400 ppm to 10,000 ppm, or 500 ppm to 10,000 ppm, or 600 ppm to 10,000 ppm, or 700 ppm to 10,000 ppm, or 800 ppm to 10,000 ppm, or 900 ppm to 10,000 ppm, or 1000 ppm to 10,000 ppm, or 1500 ppm to 10,000 ppm, or 2000 ppm to 10,000 ppm, or 3000 ppm to 10,000 ppm, or 4000 ppm to 10,000 ppm, or 5000 ppm to 10,000 ppm, or 6000 ppm to 10,000 ppm, or 7000 ppm to 10,000 ppm, or 8000 ppm to 10,000 ppm, or 9000 ppm to 10,000 ppm, or 0.1 ppm to 9000 ppm, or 0.1 ppm to 8000 ppm, or 0.1 ppm to 7000 ppm, or 0.1 ppm to 6000 ppm, or 0.1 ppm to 5000 ppm, or 0.1 ppm to 4000 ppm, or 0.1 ppm to 3000 ppm, or 0.1 ppm to 2000 ppm, or 0.1 ppm to 1000 ppm, or 0.1 ppm to 500 ppm, or 0.1 ppm to 100 ppm, or 0.1 ppm to 10 ppm, or 0.1 ppm to 1 ppm, or 1 ppm to 1000 ppm, or 1 ppm to 500 ppm, or 10 ppm to 1000 ppm, or 10 ppm to 500 ppm, or 100 ppm to 1000 ppm, or 100 ppm to 500 ppm, or 100 ppm to 5000 ppm, or 500 ppm to 5000 ppm, or 600 ppm to 5000 ppm, or 700 ppm to 5000 ppm, or 800 ppm to 5000 ppm, or 900 ppm to 5000 ppm, or 1000 ppm to 5000 ppm, or 1500 ppm to 5000 ppm, or 2000 ppm to 5000 ppm, or 3000 ppm to 5000 ppm, or 4000 ppm to 5000 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 1000 ppm to 1500 ppm, or 1500 ppm to 2000 ppm, or 2000 ppm to 2500 ppm, or 2500 ppm to 3000 ppm, or 3000 ppm to 3500 ppm, or 3500 ppm to 4000 ppm, or 4000 ppm to 4500 ppm, or 4500 ppm to 5000 ppm, or 5000 ppm to 5500 ppm, or 5500 ppm to 6000 ppm, or 6000 ppm to 6500 ppm, or 6500 ppm to 7000 ppm, or 7000 ppm to 7500 ppm, or 7500 ppm to 8000 ppm, or 8000 ppm to 8500 ppm, or 8500 ppm to 9000 ppm, or 9000 ppm to 9500 ppm, or 9500 ppm to 10,000 ppm by weight or w/v (where specified) of an AI composition in a solvent.

In embodiments the solvent comprises, consists essentially of, or consists of one or more compounds that are flammable, that is, the solvent includes one or more compounds having a flashpoint of 100° C. or less. In embodiments the solvent comprises, consists essentially of, or consists of one or more compounds having a flashpoint of 100° C. or less, and/or one or more compounds having a flashpoint of 90° C. or less, and/or one or more compounds having a flashpoint of 80° C. or less, and/or one or more compounds having a flashpoint of 70° C. or less, and/or one or more compounds having a flashpoint of 60° C. or less, and/or one or more compounds having a flashpoint of 50° C. or less, and/or one or more compounds having a flashpoint of 40° C. or less. In embodiments the solvent comprises, consists essentially of, or consists of one or more compounds having a flashpoint between 20° C. and 30° C., and/or one or more compounds having a flashpoint between 30° C. and 40° C., and/or one or more compounds having a flashpoint between 40° C. and 50° C., and/or one or more compounds having a flashpoint between 50° C. and 60° C., and/or one or more compounds having a flashpoint between 60° C. and 70° C., and/or one or more compounds having a flashpoint between 70° C. and 80° C., and/or one or more compounds having a flashpoint between 80° C. and 90° C., and/or one or more compounds having a flashpoint between 90° C. and 100° C.

In embodiments the solvent includes one or more compounds that are combustible, that is, the solvent includes one or more compounds having a flashpoint between 100° C. and 150° C. In embodiments the solvent comprises, consists essentially of, or consists of one or more compounds having a flashpoint between 100° C. and 110° C., and/or one or more compounds having a flashpoint between 110° C. and 120° C., and/or one or more compounds having a flashpoint between 120° C. and 130° C., and/or one or more compounds having a flashpoint between 130° C. and 140° C., and/or one or more compounds having a flashpoint between 140° C. and 150° C. In embodiments the solvent includes a mixture of combustible and flammable compounds.

In embodiments, the solvent further comprises an oil, that is, a compound or a mixture of two or more compounds that is liquid at 25° C./1 atm, and has a flashpoint of greater than 100° C., and is insoluble in water. Exemplary oils include mineral oils (CAS No. 63568-29-6) and silicone oils.

In embodiments, the solvent excludes C5-C12 aliphatic hydrocarbons, which include but are not limited to hexane, heptane, decane, and the like.

In embodiments, the solvent includes one or more of: toluene, xylene, heavy aromatic naphtha, diesel, kerosene, heavy aromatic distillate, or a gasoline. In embodiments, the solvent comprises, consists essentially of, or consists of an aromatic compound selected from toluene, xylene, heavy aromatic naphtha, or a mixture of two or more thereof. In embodiments, the solvent comprises, consists essentially of, or consists of a fuel fluid selected from diesel fuels, kerosenes, heavy aromatic distillates, or gasolines. In embodiments, the solvent comprises, consists essentially of, or consists of a mixture of two or more compounds, wherein a proportion of any two compounds of the solvent mixture is 100:1 to 1:100 by weight or by volume, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 by weight or by volume. In some embodiments, the solvent excludes C5-C12 aliphatic hydrocarbon compounds, which include but are not limited to n-hexane, cyclohexane, heptane, n-decane, and isodecane.

In embodiments, an injectable AI composition is an injectable AI solution, that is, the injectable AI composition is a single-phase liquid mixture comprising, consisting essentially of, or consisting of a solvent and an AI composition. In embodiments, the injectable AI composition is an injectable AI solution over the entire range of 0° C. to 100° C. at 1 atm, or over a substantial portion of the range of 0° C. to 100° C. at 1 atm, for example between 5° C. and 100° C., or between 0° C. and 90° C., or between 0° C. and 80° C., or between 0° C. and 70° C., or between 0° C. and 60° C., or between 5° C. and 90° C., or between 5° C. and 80° C., or between 5° C. and 70° C., or between 5° C. and 60° C., or between 10° C. and 90° C., or between 10° C. and 80° C., or between 10° C. and 70° C., or between 10° C. and 60° C. at 1 atm.

In embodiments, an injectable AI solution is a stable injectable AI solution, that is, the injectable AI solution does not undergo phase separation or gelation, and remains a single liquid phase when subjected to conditions of temperature and pressure present during one or more subsea umbilical injections. Accordingly, in embodiments, an injectable AI solution is disposed within a subsea umbilical, wherein the subsea umbilical is in fluid contact with a subsea reservoir. In embodiments, the injectable AI solution disposed within the subsea umbilical is a stable injectable AI solution. In embodiments, the subsea umbilical is one part of a subsea tree.

In embodiments, an injectable AI composition further includes a total of 0.1 ppm to 10,000 ppm of one or more adjuvants selected from one or more antipolymerants, one or more paraffin inhibitors, one or more corrosion inhibitors, one or more antiscale agents, one or more defoaming agents, one or more emulsifiers, one or more demulsifiers, and one or more biocides.

The injectable AI compositions are useful for injecting into a subterranean reservoir, in particular a subsea reservoir. Injection of an injectable AI composition into a reservoir, such as the wellhead of a reservoir, obtains a treated crude oil having unexpectedly superior asphaltene superior asphaltene inhibition (AI) properties.

Also disclosed herein are methods of recovering a hydrocarbon from a reservoir, the methods comprising, consisting essentially of, or consisting of combining a solvent with 0.1 ppm to 10,000 ppm by weight of an AI composition to form an injectable AI composition; contacting the injectable AI composition with a crude oil disposed within the reservoir, to form a treated crude oil; and collecting the treated crude oil from the reservoir. In embodiments, the reservoir is a subsea reservoir, and the contacting includes applying an injectable AI solution to a subsea umbilical, and flowing the injectable AI solution through the subsea umbilical and into the subsea reservoir. In embodiments, the reservoir is a subsea reservoir, and the contacting includes applying a stable injectable AI solution to a subsea umbilical, and flowing the stable injectable AI solution through the subsea umbilical and into the subsea reservoir. In embodiments, a temperature proximal to the injectable AI composition during the flowing through the umbilical is between 0° C. and 90° C. In embodiments, a temperature proximal to the injectable AI composition varies by 5° C. to 90° C. during the flowing through the umbilical. In embodiments, a pressure proximal to the injectable AI composition during the flowing through the umbilical is 0.1 MPa to 40 MPa. In embodiments, a pressure proximal to the treatment composition varies by 0.1 MPa to 40 MPa during the flowing through the umbilical. In embodiments, during the flowing through the umbilical, the injectable AI composition is an injectable AI solution. In embodiments, the injectable AI solution is stable injectable AI solution, that is, the injectable AI solution remains a solution throughout the entirety of the flowing through the umbilical and does not undergo phase separation, freezing, or gelation therein.

In embodiments, the injecting causes the injectable AI composition to contact the contents of the reservoir, wherein the contacting is prior to collecting. That is, the injectable AI compositions are injected at a wellhead to contact a crude oil within the reservoir, thereby forming a treated crude oil; and the treated crude oil is collected. Accordingly, the collecting is collecting a treated crude oil from the reservoir.

In embodiments, the crude oil located within the reservoir includes asphaltene, for example between 1 wt % and 40 wt % asphaltene, such as 1 wt % to 5 wt %, or 5 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or depending on the location of the reservoir. In embodiments the asphaltene is dispersed, that is, entrained or included within the crude oil, and may be dissolved or partially dissolved therein; and can become associated with solid-liquid interfaces encountered during extraction of the crude oil from the reservoir, causing asphaltene fouling of surfaces contacted with the untreated crude oil. The methods herein address the foregoing problem by reducing or eliminating asphaltene fouling. Accordingly, disclosed herein are methods of reducing or eliminating asphaltene fouling of a crude oil, by combining the crude oil with an asphaltene inhibitor (AI) composition.

Accordingly, methods of treating a crude oil include contacting an AI composition with a crude oil to obtain a treated crude oil, wherein the treated crude oil obtains a reduced amount of asphaltene fouling compared to the same crude oil prior to the combining, tested under the same conditions of temperature and pressure. In embodiments, the combining is combining an injectable AI composition. In embodiments, the injectable AI composition is an injectable AI solution. In embodiments, the injectable AI solution is a stable injectable AI solution.

In some embodiments, a crude oil is located in a subsea reservoir, and the contacting is injecting an injectable AI solution into a wellhead of the subsea reservoir, further wherein the injecting is flowing the injectable AI solution through an umbilical. An umbilical is a tube—that is, an annular conduit, or annulus—extending from a first end situated above the surface of the sea to a second end in fluid contact with a subsea reservoir at a wellhead thereof. Umbilicals are widely used in the offshore oil extraction industry to convey control and production treatment fluids from a platform situated near the sea surface to the subsea wellhead.

Accordingly, in embodiments, an umbilical second end is located 50 m to 2000 m beneath the surface of a body of water, such as 50 m to 100 m, or 100 m to 150 m, or 150 m to 200 m, or 200 m to 250 m, or 250 m to 300 m, or 300 m to 400 m, or 400 m to 500 m, or 500 m to 600 m, or 600 m to 700 m, or 700 m to 800 m, or 800 m to 900 m, or 900 m to 1000 m, or 1000 m to 1100 m, or 1100 m to 1200 m, or 1200 m to 1300 m, or 1300 m to 1400 m, or 1400 m to 1500 m, or 1500 m to 1600 m, or 1600 m to 1700 m, or 1700 m to 1800 m, or 1800 m to 1900 m, or 1900 m to 2000 m beneath the surface of a body of water such as an ocean, sea, or freshwater lake. During subsea injecting, an injectable AI solution is applied to the first end of an umbilical, located above the surface of the body of water; and the applied solution flows downward through the umbilical annulus toward umbilical second end, located within or proximal to the wellhead.

In some embodiments, an injectable AI solution is applied to umbilical first end, and the applied injectable AI solution traverses the umbilical under an applied pressure, such as a pressure applied by a direct drive pump, a hydraulic pump, or a peristaltic pump. In some embodiments, a flow of an injectable AI solution through an umbilical is a metered flow, wherein a selected flow rate of the injectable AI solution is applied to the umbilical. In some embodiments, a flow of an injectable AI solution through an umbilical is a controlled flow, wherein a volume of the injectable AI solution injected into the wellhead per unit of time is adjusted automatically or manually by an operator in response to external criteria such as the rate of flow of (treated) crude oil from the wellhead. In embodiments, the umbilical is connected to a subsea tree, and a flow of injectable AI solution is controlled or metered using the subsea tree. In embodiments, subsea trees operate to control the flow both into and out of subsea a well, further while staking the umbilical and other tubes and devices for subsea oil extraction to the seafloor and also to above-water oil extraction facilities.

Accordingly, in embodiments, injecting an injectable AI solution into a subsea reservoir includes subjecting the injectable AI solution to temperatures varying between 0° C. and 100° C., and pressure between 0.1 MPa to 40 MPa proximal to the umbilical during the injecting. Such variable conditions may be encountered during injection into a subsea reservoir, as an injectable AI solution flows from above sea level to the wellhead 50 m to 2000 m below the sea surface.

In embodiments, an injectable AI solution is a stable injectable AI solution, meaning that it does not undergo phase separation, freezing, or gelation when exposed to the conditions encountered during umbilical injecting, that is, while traversing an umbilical toward a subsea wellhead. Accordingly, in some embodiments, a stable injectable AI solution obtains a solution at pressures between 0.1 MPa to 40 MPa. In some embodiments, a stable injectable AI solution obtains a solution at temperatures between 0° C. and 100° C. In some embodiments, a stable injectable AI solution obtains a solution at temperatures between 0° C. and 100° C., further at any pressure between 0.1 MPa to 40 MPa.

In some embodiments, a stable injectable AI solution is an injectable AI solution that is a solution at temperatures between 0° C. and 100° C., further at any pressure between 0.1 MPa to 40 MPa, and further wherein the temperature varies by 5° C. to 90° C. during the injecting, that is, the temperature varies over a range of 5° C. to 10° C., or 10° C. to 15° C., or 15° C. to 20° C., or 20° C. to 25° C., or 25° C. to 30° C., or 35° C. to 40° C., or 40° C. to 45° C., or 45° C. to 50° C., or 50° C. to 55° C., or 55° C. to 60° C., or 60° C. to 65° C., or 65° C. to 70° C., or 70° C. to 75° C., or 75° C. to 80° C., or 80° C. to 85° C., or 85° C. to 90° C. during the injecting; and/or further wherein the pressure varies by 0.1 MPa to 40 MPa during the injecting, that is, the pressure varies over a range of 0.1 MPa to 0.5 MPa, or 0.5 MPa to 1.0 MPa, or 1.0 MPa to 2.0 MPa, or 2.0 MPa to 5 MPa, or 5 MPa to 10 MPa, or 10 MPa to 15 MPa, or 15 MPa to 20 MPa, or 20 MPa to 25 MPa, or 25 MPa to 30 MPa, or 30 MPa to 35 MPa, or 35 MPa to 40 MPa during the injecting.

In one exemplary but nonlimiting embodiment, a stable injectable AI solution obtains a solution during an umbilical injection into a subsea reservoir, during which the temperature and pressure proximal to the umbilical is 20° C./0.1 MPa at the umbilical first end situated above the sea surface; 5° C./25 MPa at a location on the umbilical 1000 to 1200 meters below the surface of the sea; and 90° C./30 MPa at the umbilical second end, located in fluid contact with the subsea wellhead 1500 meters below the surface of the sea. During such an exemplary injection, the stable injectable AI solution is subjected to a temperature variation of 85° C., and pressure variation of 29.9 MPa, while remaining a solution. Other exemplary conditions to which materials flowing within a subsea umbilical are subjected will be readily envisioned by one of ordinary skill in the art of subsea injections, and it will be appreciated that the stable injectable AI solutions described herein obtain stable solutions when subjected to any of these conditions.

Upon contacting an injectable AI composition with a crude oil located within a wellhead, the crude oil is transformed into a treated crude oil. The treated crude oil is suitably collected using conventional crude oil collection processes; and may be further purified or refined.

Accordingly, disclosed herein are treated crude oils. A treated crude oil includes a crude oil and 0.1 ppm to 10,000 ppm by weight of an AI composition. A treated crude oil is formed by contacting an injectable AI composition with a crude oil, as noted above. Also as noted above, a treated crude oil is suitably collected using conventional crude oil collection processes.

In embodiments, a treated crude oil comprises, consists essentially of, or consists of a crude oil combined with or mixed with an injectable AI composition. In embodiments, a treated crude oil comprises, consists essentially of, or consists of a crude oil combined with or mixed with 0.01 ppm to 10,000 ppm by weight of an injectable AI composition. Often, a treated crude oil comprises, consists essentially of, or consists of a mixture of crude oil and 0.01 ppm to 1000 ppm by weight of an AI composition (that is, a sulfonate material and an amine condensate), such as 0.1 ppm to 1000 ppm, or 1 ppm to 1000 ppm, or 10 ppm to 1000 ppm, or 50 ppm to 1000 ppm, or 100 ppm to 1000 ppm, or 200 ppm to 1000 ppm, or 300 ppm to 1000 ppm, or 400 ppm to 1000 ppm, or 500 ppm to 1000 ppm, or 600 ppm to 1000 ppm, or 700 ppm to 1000 ppm, or 800 ppm to 1000 ppm, or 900 ppm to 1000 ppm, or 0.01 ppm to 500 ppm, or 0.1 ppm to 500 ppm, or 1 ppm to 500 ppm, or 10 ppm to 500 ppm, or 100 ppm to 500 ppm, or 200 ppm to 500 ppm, or 300 ppm to 500 ppm, or 400 ppm to 500 ppm, or 0.01 ppm to 0.1 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 0.1 ppm to 100 ppm, or 1 ppm to 100 ppm, or 10 ppm to 100 ppm, or 100 ppm to 500 ppm, or 500 ppm to 700 ppm, or 700 ppm to 1000 ppm by weight of an AI composition.

The treated crude oil obtains unexpectedly superior asphaltene inhibiting properties, wherein “inhibiting” refers to asphaltenes present in the crude oil, and the reduction or elimination of the association of the asphaltenes with a solid-liquid interface, that is, deposition of asphaltene solids onto the surface of tubes or pipes contacted by the crude oil having the asphaltene entrained therein. In embodiments, a crude oil includes as much as 1 wt % to 40 wt % asphaltene content, often between 5 wt % and 20 wt % asphaltene, wherein the asphaltene is dispersed, that is, entrained or included within the crude oil, and may be dissolved or partially dissolved therein; further wherein the asphaltene can become associated with solid-liquid interfaces encountered during extraction of the crude oil from the reservoir. Accordingly, asphaltene fouling of the interior surfaces of pipes, tubes, and other equipment contacted by the crude oil during the extraction thereof from a reservoir leads to extensive issues with flow control of the extraction process overall, and down time for cleaning of fouled surfaces. Fouling can become more extensive when the extraction is from a subsea reservoir, where changes in pressure applied to the crude oil as it is lifted from the subsea reservoir to a point above the surface of the sea exacerbate the instability of the asphaltene dispersed within the crude oil.

In embodiments, a treated crude oil obtains at least a 30% reduction in asphaltene fouling by weight, compared to an untreated crude oil obtained from the same reservoir, and in embodiments up to a 99% reduction in asphaltene fouling by weight compared to an untreated crude oil obtained from the same reservoir, where the reduction in asphaltene fouling—that is, asphaltene inhibition—is determined by mixing a crude oil with 1000 ppm by weight or by weight/volume of an AI composition; heating the mixture in a vessel to a temperature in excess of 100° C.; allowing the vessel contents to cool to a temperature of 64° C. or less; then measuring the weight of residual materials that remain on the bottom of the vessel after pouring the liquid contents from the vessel, washing the residual materials with hexane, washing the residual materials further with toluene, and drying the final residue remaining; and comparing the amount of residue remaining after testing the treated crude oil to the amount remaining after carrying out the same test on an untreated sample of the crude oil obtained from the same reservoir.

Accordingly, a treated crude oil obtains a 30%-99% reduction in asphaltene fouling by weight, compared to the corresponding untreated crude oil, that is, an untreated crude oil obtained from the same reservoir. Stated differently, compared to the weight of asphaltene deposited on a surface by contacting the surface with an untreated crude oil, 30%-90% less asphaltene by weight is deposited on the surface by a corresponding treated crude oil subjected to the same contacting conditions of temperature and pressure, for example 30%-90%, or 30% to 80%, or 30% to 70%, or 30% to 60%, or 30% to 50%, or 30% to 40%, or 30% to 35%, or 35% to 40%, or 40% to 45%, or 45% to 50%, or 50% to 55%, or 55% to 60%, or 60% to 65%, or 65% to 70%, or 70% to 75%, or 75% to 80%, or 80% to 85%, or 85% to 90%, or 90% to 95%, or 95% to 99% less asphaltene by weight is deposited on the surface by a treated crude oil subjected to the same contacting conditions of temperature and pressure as the corresponding untreated crude oil.

Even further, a treated crude oil having 1000 ppm by weight or weight/volume of an AI composition—that is, 1000 ppm total of a mixture of a sulfonate materials and an amine condensate—obtains a 5% to 50% reduction in asphaltene fouling compared to a crude oil obtained from the same reservoir and including 1000 ppm by weight or weight/volume of the sulfonate material alone. That is, an amount by weight of an AI composition—a mixture of sulfonate material and an amine condensate—obtains improved asphaltene inhibition in a crude oil when compared to the same total weight of the sulfonate material in the absence of the amine condensate. This finding is unexpected because while amine condensates are employed industrially as corrosion inhibitors, amine condensates are not associated with asphaltene inhibition and do not obtain asphaltene inhibition in the absence of a sulfonate material. Accordingly, in embodiments, a treated crude oil having 1000 ppm by weight or weight/volume of an AI composition obtains a reduction of 5% to 45%, or 5% to 40%, or 5% to 35%, or 5% to 30%, or 5% to 25%, or 5% to 20%, or 5% to 15%, or 5% to 10%, or 10% to 15%, or 15% to 20%, or 20% to 25%, or 25% to 30%, or 30% to 35%, or 35% to 40%, or 40% to 45%, or 45% to 50% in asphaltene fouling compared to a crude oil obtained from the same reservoir and including 1000 ppm by weight or weight/volume of the sulfonate material alone.

Even further, we have found that in embodiments, crude oils including coke-like asphaltenes (CLAs), which are defined as having an overall chemical composition wherein the ratio of hydrogen to carbon is close to 1, for example between 1.2 and 1, or even between 1.1 and 1, are suitably addressed using the AI compositions. CLAs are recognized in the industry as tending to be less responsive to conventional asphaltene inhibitors than non-CLAs and as a result can be responsible for significant asphaltene deposition (fouling) of surfaces. suitably addressed by the AI compositions described herein. Accordingly, a treated crude oil formed from a CLA-bearing crude oil obtains a 30%-99% reduction in asphaltene fouling when compared to the corresponding untreated CLA-bearing crude oil; and more specifically obtains a 1%-50% reduction in CLA fouling when compared to the corresponding untreated CLA-bearing crude oil, for example 1% to 5%, or 5% to 10%, or 10% to 20%, or 20% to 30%, or 30% to 40%, or 40% to 50% reduction in CLA fouling when compared to the corresponding untreated CLA-bearing crude oil.

### EXPERIMENTAL SECTION

### Example 1

Asphaltene inhibition formulations were prepared in accordance with Formulations 1-4 of Table 1 by admixing solvents xylene or heavy aromatic naphtha (HAN) with ammonium 2,3-diisononylnaphthylene sulfonate; and further with and a tall oil fatty acid-diethylene triamine (TOFA-DETA) condensate in some cases. All Formulations 1-4 formed transparent solutions at ambient laboratory temperature upon preparation. Each of Formulations 1-4 was tested for cold stability using the following Cold Stability Test. Results of the Cold Stability Test of Formulations 1-4 are noted in Table 1. Formulations 2 and 3 did not pass the Cold Stability Test, and were observed to form gel and/or precipitate. Formulations 2 and 3 were not further tested.

Cold Stability Test: Two centrifuge tubes are filled with 8-10 mL each of the formulation to be tested. The tubes are introduced to a cold centrifuge equilibrated at either 2 C or 4 C, and centrifuged at 2,000 RPM for a period of 7 days while the temperature is maintained. At the end of the 7 day period, the centrifuge is stopped and tubes are removed from the centrifuge and carefully inverted for observation. Cold Stable formulations are free of all signs of particulates, gel, or phase changes.

TABLE 1
Asphaltene inhibition formulations
and outcome of cold stability test.

| | Ammonium 2,3- | | | |
|---|---|---|---|---|
| Formulation | diisononylnaphthalene | TOFA-DETA | | Cold |
| No. | sulfonate | condensate | Solvent | stable? |
| n/a (blank) | 0 | 0 | 0 | n/a |
| 1 | 15 wt/vol % | 0 | xylene | Yes |
| 2 | 20 wt/vol % | 0 | HAN | No |
| 3 | 30 wt/vol % | 0 | HAN | No |
| 4 | 20 wt/vol % | 5 wt % | HAN | Yes |

### Example 2

Asphaltene fouling performance of Formulations 1 and 4 was measured as follows. A Paar glass reactor vessel was fitted with overhead stirrer, thermocouple, and heating mantle, and having a location for mounting a 6 cm×10 cm metal mesh insert on the vessel bottom. For each measurement, a fresh 6 cm×10 cm stainless steel mesh piece was cut and weighed; then fitted to the bottom of the clean reactor. Then 20 mL of a crude oil obtained from a reservoir in the Gulf of Mexico and determined to have 14 wt % asphaltene content (“GoM crude oil”) was added to the reactor, along with a total of 1000 ppm by weight/volume of formulation actives to be tested (if any).

Once all additions to the reactor were made, the reactor was closed, and stirring at 436 rpm was started. Then the heating mantle was turned on and the contents of the reactor were allowed to warm to a set temperature of 161° C. while the stirring was continued. The contents of the vessel were maintained at the set temperature and a timer was started. When the timer reached 90 minutes, the heating mantle was shut off and the vessel immediately immersed in cool tap water. The vessel was held in the cool water until the contents reached a temperature of 64° C. or lower; then the vessel was slowly opened to release any pressure; and the metal mesh removed therefrom and dried in an oven set to 80° C. The mesh was then washed with cyclohexane, dried in an oven set to 80° C., and cooled; and finally the mesh was washed with toluene, dried in an oven set to 80° C., and cooled. The washed, dried mesh was weighed, and the weight of the tared mesh screen was subtracted from this to reveal the mass of materials associated with the mesh screen. The mass of the materials associated with the mesh screen indicates the relative amount of asphaltene fouling expected by a crude oil, or by a treated crude oil, during extraction thereof.

The foregoing asphaltene fouling test using untreated GoM crude oil showed that the 20 mL of GoM crude oil deposited 19 mg residue on the mesh screen.

In sharp contrast, 1000 ppm ammonium 2,3-diisononylnaphthalene sulfonate, that is, Formulation 1, added to the GoM crude oil obtained 6 mg residue (about 68% less residue) in the asphaltene fouling test.

Finally, 1000 ppm by weight of Formulation 4 actives, that is, about 800 ppm ammonium 2,3-diisononylnaphthylene sulfonate and about 200 ppm TOFA-DETA condensate, was added to 20 mL of the GoM crude oil and this combination was subjected to the asphaltene fouling test to result in 4.5 mg residue deposited on the mesh screen, that is, a 76% reduction compared to the untreated GoM crude oil. Further, 1000 ppm Formulation 4 actives (80:20 mixture of sulfonate salt and amine condensate) obtained a 25% reduction in asphaltene fouling compared to 1000 ppm Formulation 1 actives (sulfonate salt alone).

What is claimed is:

1. An asphaltene inhibiting composition comprising a mixture of a sulfonate material with an amine condensate, wherein the sulfonate material comprises one or more sulfonate salts, one or more sulfonate polymers, or a mixture thereof; and the amine condensate comprises a reaction product of one or more organic acids with one or more organic compounds having at least two amine groups.

2. The asphaltene inhibiting composition of claim 1 wherein a weight proportion of the sulfonate material to the amine condensate is between 100:1 and 1:100.

3. The asphaltene inhibiting composition of claim 1 wherein the sulfonate material comprises one or more sulfonate salts and one or more sulfonate polymers present in a weight proportion of 100:1 to 1:100.

4. The asphaltene inhibiting composition of claim 1 wherein one or more of the sulfonate salts have a structure corresponding to the formula (R—SO³⁻)ₙXⁿ⁺, wherein n is an integer between 1 and 4; R is a hydrocarbyl moiety having between 10 and 40 carbons and optionally including one or more hydroxyl moieties; and
where n is 1, X is Na, Ka, Li, K, NH₄, NH₃—CH₂—CH₂—OH, or NH₂(CH₂—CH₂—OH)₂;
where n is 2, X is Mg, Zn, Zr, Ba, or Ca; where n=3, X is Al, Mn, or Fe;
where n is 3, X is Al, Mn, or Fe; and
where n is 4, X is Ti or Zr.

5. The asphaltene inhibiting composition of claim 4 wherein R is aryl or alkaryl, optionally wherein the alkaryl is 2,3-dialkylnaphthyl.

6. The asphaltene inhibiting composition of claim 5 wherein the 2,3-dialkylnaphthyl is 2,3-diisononylnaphthyl, further wherein n is 1 and X is NH₄.

7. The asphaltene inhibiting composition of claim 1 wherein one or more of the sulfonate polymers is a poly(methylene naphthalene sulfonate) homopolymer or copolymer.

8. The asphaltene inhibiting composition of claim 1 wherein the amine condensate reaction product comprises an imidazoline having a structure corresponding to formula (4): 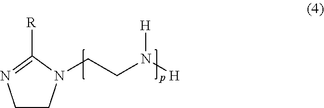
wherein R² is a linear or branched alkyl, alkenyl, alkaryl, or aryl group having 10 to 30 carbons and p is an integer between 1 and 5.

9. The asphaltene inhibiting composition of claim 8 wherein p is 1 and R² comprises C₁₇H₃₃.

10. The asphaltene inhibiting composition of claim 1 wherein the amine condensate reaction product is the reaction product of diethylene triamine with a tall oil fatty acid.

11. An injectable asphaltene inhibiting composition comprising 0.1 ppm to 10,000 ppm by weight/volume of the asphaltene inhibiting composition of claim 1 in a solvent, wherein the solvent comprises a single compound or a mixture of two or more compounds that is liquid or substantially liquid within at least a portion of the range between 0° C. and 100° C. at 1 atmosphere pressure.

12. The injectable asphaltene inhibiting composition of claim 11 wherein one or more of the compounds of the solvent is insoluble in water, and/or wherein one or more of the compounds of the solvent has a flashpoint of 100° C. or less.

13. The injectable asphaltene inhibiting composition of claim 11 wherein the solvent is selected from toluene, xylene, heavy aromatic naphtha, diesel fuels, kerosenes, heavy aromatic distillates, gasolines, or any mixture thereof.

14. The injectable asphaltene inhibiting composition of claim 11, wherein the injectable asphaltene inhibiting composition is an injectable asphaltene inhibiting solution.

15. The injectable asphaltene inhibiting composition of claim 14 disposed within a subsea umbilical, wherein the subsea umbilical is in fluid contact with a subsea reservoir, optionally wherein the subsea umbilical is one part of a subsea tree.

16. A method of recovering a hydrocarbon from a reservoir, the method comprising
(a) contacting an injectable asphaltene inhibition composition of claim 11 with a crude oil disposed within the reservoir to form a treated crude oil; and
(b) collecting the treated crude oil from the reservoir.

17. The method of claim 16 wherein the injectable asphaltene inhibition composition is an injectable asphaltene inhibition solution.

18. The method of claim 16 wherein the reservoir is a subsea reservoir, and the contacting comprises applying the treatment composition to a subsea umbilical, and flowing the treatment composition through the subsea umbilical and into the subsea reservoir.

19. The method of claim 18 wherein a temperature proximal to the injectable asphaltene inhibition composition during the flowing is between 0° C. and 90° C., and/or wherein a temperature proximal to the injectable asphaltene inhibition composition varies by 5° C. to 90° C. during the flowing.

20. The method of claim 18 wherein a pressure proximal to the injectable asphaltene inhibition composition during the flowing is between 0.1 MPa and 40 MPa, and/or wherein a pressure proximal to the injectable asphaltene inhibition composition varies by 0.1 MPa to 40 MPa during the flowing.

21. A treated crude oil comprising
a crude oil comprising an asphaltene; and
0.1 ppm to 10,000 ppm by weight/volume of an asphaltene inhibition composition of claim 1.

22. The treated crude oil of claim 21 wherein the asphaltene is present in the crude oil in an amount between 1 wt % and 40 wt %.

23. The treated crude oil of claim 21 wherein the asphaltene comprises coke-like asphaltene.
